(19) United States
(12) Patent Application Publication
(10) Pub. No.: US 2024/0354468 A1
(43) Pub. Date: Oct. 24, 2024

(54) METHOD OF DETERMINING AN INOPERABLE TIME PERIOD FOR AN ASSET

(71) Applicant: Renew-Risk Limited, Wimborne (GB)

(72) Inventors: Subhamoy Bhattacharya, London (GB); Gaurav Chawla, Essex (GB); Joshua Macabuag, Hertfordshire (GB); Ashima Gupta, Essex (GB)

(21) Appl. No.: 18/137,015

(22) Filed: Apr. 20, 2023

(51) Int. Cl. G06F 30/23

(52) U.S. Cl. CPC G06F 30/23; G06F 2111/10; G06F 2113/06

(57) ABSTRACT

A method of determining an average duration for a time period that the at least one first asset, or a second asset operatively connected to the at least one first asset, is inoperable is described. The method comprises obtaining a location of at least one first asset associated with energy generation, transmission or storage. The method comprises obtaining a first probability of a natural adverse event occurring at the location of the at least one first asset. The method comprises obtaining a second probability of a non-natural adverse event occurring at the location of the at least one first asset. The method comprises determining a third probability of at least one damage state of the at least one first asset from the first and second probabilities. The method comprises determining an average duration for a time period that the at least one first asset, or a second asset operatively connected to the at least one first asset, is inoperable based on the third probability of the at least one damage state of the first asset.

### FIELD

The present invention relates to a method of determining an inoperable time period for an asset associated with energy generation, transmission or transportation, use, or storage.

### BACKGROUND

Offshore Wind Farms (OWF) are a scalable clean energy source deployed deep in the sea (water depth up to 200 m) far away from the shore (100 miles from seacoast). These are new expensive assets (typical average value of 1bN$ for a 500 MW Power plant) and are currently being installed in a wide range of geographical areas. These assets can be classified as: generation assets (turbines), transmission assets (substations, transformers and cables) and storage assets (batteries, pumped hydroelectric power, compressed air, flywheels, thermal storage).

OWF are only revenue generating when both generation and transmission assets are operational. Wind Turbine Generators (WTG) are going through a massive innovation with rated power increasing from 3.6MW to 18 MW within a decade. Few aspects are important in terms of sizes: length of the tower sticking above the seabed (60 m to 200 m), length of the blades (40 m to 125 m), mass of the Rotor-Nacelle Assembly (RNA) that sits on the top of the tower which houses the power generation equipment. Furthermore, WTG supporting system, that is, the foundation to the seabed can be either grounded (fixed to the seabed) or floating (tethered or anchored to the seabed through mooring lines).

There are many risks associated with offshore wind farms, for example, natural hazards, for example, tropical cyclones, winter storms, earthquakes and their related multi-hazards for example, ground shaking, subsurface liquefaction, submarine landslides, tsunami etc., and it is therefore necessary to assess the performance in view of these risks for these assets. Additionally, there may be non-natural risks to offshore wind farms, for example, corrosion, metal fatigue, ware on the mechanical components, and external risks, such as cyber attacks on the systems controlling the wind farms.

Interruption of functionality in any one of the assets associated with the power generation, transmission and storage system of an OWF, may result in the system being inoperable for a period of time, and no electricity being generated. There is therefore a need to assess these risks to the individual assets to better understand the risk to the whole system (e.g., an OWF) being inoperable.

### REFERENCES

[1] Kolli, S., Dammala, P. K., Bhattacharya, S., Fan, C., Wang, T., & Cui, L. (2023). Offshore wind farms as additional coolant power sources to enhance seismic resilience of nuclear power plants-A case study. Nuclear Engineering and Design, 405, 112204.
[2] Bhattacharya, S., & Goda, K. (2016). Use of offshore wind farms to increase seismic resilience of Nuclear Power Plants. Soil Dynamics and Earthquake Engineering, 80, 65-68.
[3] Bhattacharya, S., Amani, S., Prabhakaran, A., & Macabuag, J. (2022). Hazard considerations in the vulnerability assessment of offshore wind farms in seismic zones. Earthquake Engineering and Resilience, 1 (1), 88-109.
[4] S. Bhattacharya, Design of Foundations for Offshore Wind Turbines, First Edit. Chichester, Wiley, 2019. doi: 10.1002/9781119128137
[5] Menéndez-Vicente, C., López-Querol, S., Bhattacharya, S., & Simons, R. (2023). Numerical study on the effects of scour on monopile foundations for Offshore Wind Turbines: The case of Robin Rigg wind farm. Soil Dynamics and Earthquake Engineering, 167, 107803.
[6] Amani, S., Prabhakaran, A., & Bhattacharya, S. (2022). Design of monopiles for offshore and nearshore wind turbines in seismically liquefiable soils: Methodology and validation. Soil Dynamics and Earthquake Engineering, 157, 107252.
[7] Rouholamin, M., Lombardi, D., & Bhattacharya, S. (2022). Experimental investigation of transient bending moment of piles during seismic liquefaction. Soil Dynamics and Earthquake Engineering, 157, 107251.
Individual VF
[8] Mo, Renjie, Renjing Cao, Minghou Liu, Miao Li, and YunPing Huang. “Seismic fragility analysis of monopile offshore wind turbines considering ground motion directionality.” Ocean Engineering 235 (2021): 109414
[9] Yeter, B., Tekgoz, M., Garbatov, Y., & Guedes Soares, C. (2020). Fragility analysis of an ageing monopile offshore wind turbine subjected to simultaneous wind and seismic load. Safety in Extreme Environments, 2, 155-170.
[10] Wilkie, D., & Galasso, C. (2020). A probabilistic framework for offshore wind turbine loss assessment. Renewable Energy, 147, 1772-1783.
[11] Ali, A., De Risi, R., Sextos, A., Goda, K., & Chang, Z. (2020). Seismic vulnerability of offshore wind turbines to pulse and non-pulse records. Earthquake Engineering & Structural Dynamics, 49 (1), 24-50.
[12] Chaudhari, Vasudeo, and Surendra Nadh Somala. “Fragility analysis of offshore wind turbine expose to near-field pulse-like ground motion.” Asian Journal of Civil Engineering 22, no. 7 (2021): 1331-1345.
[13] Wilkie, David, and Carmine Galasso. “Site-specific ultimate limit state fragility of offshore wind turbines on monopile substructures.” Engineering Structures 204 (2020): 10990
[14] Pan, Haiyang, Chao Li, and Li Tian. “Seismic fragility analysis of transmission towers considering effects of soil-structure interaction and depth-varying ground motion inputs.” Bulletin of Earthquake Engineering 19.11 (2021): 4311-4337

### SUMMARY

According to a first aspect of the invention, there is provided a method comprising obtaining a location of at least one first asset associated with energy generation, transmission, use, or storage, obtaining a first probability of a natural adverse event occurring at the location of the at least one first asset, the natural adverse event having an associated severity, obtaining a second probability of a non-natural adverse event occurring at the location of the at least one first asset, the non-natural adverse event having an associated severity, determining a third probability of at least one damage state of the at least one first asset from the first and second probabilities and their associated severities and determining an average duration for a time period that the at least one first asset, or a second asset operatively connected to the at least one first asset, is inoperable based on the third probability of the at least one damage state of the first asset.

Thus, the average annual duration an energy generation, energy transmission or energy storage device or system is not capable of generating electricity, generating hydrogen, or generating ammonia for is determined. The duration may include the time required to repair the at least one first asset to regain functionality of the first and/or second asset. This may allow a user to assess the risk associated with an energy generating, energy transmitting, or energy storage system and mitigate the risk accordingly. For example, a user may require a certain level of uninterrupted power generation, and this knowledge will enable the user to determine whether there is enough power generation, or how much extra power generation will be needed to cover their needs.

Obtaining the location may comprise receiving, deriving, or calculating the location, for example, using geolocator information. Obtaining either the first or second probability may comprise receiving the probability, deriving, or calculating the probability.

Damage state may be a physical damage state, an electronic damage state, e.g., controller, processor or other circuitry being damaged or destroyed, or a computational damage state, for example, errors in computer code or software, malicious computer code or software, (e.g., computer virus other malware etc.). Damage state may be validated using any suitable means, for example drone or satellite imagery, drone sensors (for example, sensors which may be able to detect damage associated with the asset, e.g., radio frequency identification tag sensors, magnetic sensors, or other suitable sensor). Damage state may also be validated by network-connected devices (e.g., “Internet of Things” (IoT) devices) which are capable of monitoring the at least one first asset, and, optionally, the second asset.

The time period may be a year, and thus, an average annual duration may be determined.

There may be a plurality of second assets.

The method may comprise determining an average annual financial loss based on the average duration for the time period that the at least one first asset or second asset are inoperable, and the cost of repairing the asset to return the at least one first asset and/or second asset to a functional state.

The average annual financial loss may comprise an estimate of the cost of repair of for a given asset for a particular adverse event or hazard. Furthermore, the time required to carry out the repair is also estimated which may inform the average annual financial loss. These costs may be normalised to the cost of replacement.

The location may comprise a latitude and/or a longitude.

The location may comprise a depth below sea level. The location may comprise bathymetry information, that is, the underwater depth information of a body of water. The method may further comprise obtaining time-varying information for the location, for example over a day, over a week, month, quarter, year, decade, generation, or century. The method may further comprise obtaining time-varying information for the location, for example the time of day, the time of year for the time period concerned, or time periods either side of the time period concerned. The method may further include obtaining predicted climate or weather information, for example, changes predicted from climate change models either during, or either side of the time period concerned. The time-varying information may influence the first and/or second probabilities, for example, there may be an increased risk of cyclones in 10 years' time at the location than there is at present.

Obtaining may include calculating, deriving, modelling, or receiving.

The at least first asset associated with energy generation may be a turbine.

The at least first asset associated with energy generation may be a wind turbine.

The asset associated with energy generation may be a component of a wind turbine. The asset associated with energy generation may be a turbine blade (e.g., a wind turbine blade), a generator (e.g., and electromechanical system suitable for generating electricity), a turbine tower (e.g., a structure to support the appropriate location of the turbine, or an associated component), foundations, or a transition piece.

The asset associated with transmission may be a substation, a transformer, or a cable.

For example, the cable may be a power export cable. The asset may include a hydrogen or ammonia generation, storage, or transport asset.

The asset associated with storage may be a battery, or an electrolysis plant.

The natural adverse event may comprise a seismic activity, an airflow activity, a waterflow activity, lightening, fire, or flooding.

The natural adverse event (also referred to as a hazard) may comprise a tropical cyclone, a tsunami, an earthquake, strong shaking (e.g., ground shaking), liquefaction of the substrate in which the asset is attached or located, induced slope movement, and settlement of foundation, submarine landslide, sea current, temperature, and winter storms. The natural adverse events may comprise high seabed current (e.g., causing erosion of the foundation), geology (e.g. complex geology, e.g. soft soils) at certain locations. These could be simultaneous, with a lag, or impacting or influencing each other.

An airflow activity may comprise or be a storm, a gale, a hurricane, or a cyclone. The airflow activity may include information about the scale of the activity, for example, on the Saffir-Simpson Hurricane Wind Scale.

A waterflow activity may be or comprise a wave, a tide, a stream, a current, or thermohaline circulation.

Non-natural adverse events may comprise the presence of UXO (unexploded ordnance), presence of shipwrecks and other buried objects, corrosion of components exposed to sea water, marine life growth on an asset or associated structure. Construction and commissioning risks may also be included in the non-natural adverse event probability, for example, errors or delays during construction, for example, pile run during installation, boat or other water vessel impact, pile tip buckling, buckling of suction caissons, errors in installation of components, errors in grouting of the connections, large defective components. Non-natural adverse events may comprise operational risks, for example, cyber risks (e.g. a cyber-attack), cable, and/or control system malfunctioning. Non-natural adverse events may comprise risks associated with future technological developments, for example, heavier turbine blades. Non-natural adverse events may include chemical-related events, for example a chemical spill, or a chemical explosion, for example from hydrogen or ammonia.

The probability of at least one damage state may comprise evaluating operational changes in view of the natural and non-natural hazard probability or risk. Determining the damage state may include evaluating the impact of the adverse event for the future operation of the at least one first asset. The evaluation of the impact may comprise using historical data of the natural and non-natural events at the same or similar locations, or for similar asset types.

The first probability may be determined by calculating a vulnerability of the at least one first asset.

Wherein a vulnerability may be a function relating to an adverse event metric (e.g., seismic, wind speed, water depth or depth) to damage ratio to calculate ground-up loss of the asset. The vulnerability may include a risk score associated with the asset.

Calculating the vulnerability of the at least one first asset may comprise an analytical solution, a numerical model, a statistical method, or a numerical simulation, to evaluate the likelihood and consequences of a given natural or non-natural adverse event.

The numerical model may comprise a finite element analysis.

The analytical solution may comprise a closed form formulaic solution. The statistical method may comprise a generalized linear ordinal model, a bootstrap, or a beta-distributed uncertainties. The statistical method may comprise a machine learning model.

The at least one first asset associated with energy generation, transmission or storage may be an asset associated with a wind turbine or a windfarm, and when the method comprises a numerical simulation, the simulation may comprise any of: a range of generation assets from a pre-defined list of assets categorised by: rotor nacelle assembly mass; and/or turbine blade geometry and/or material; turbine tower geometry; a range of water depths typical of a wind farm; whether the wind turbine is a grounded system or a floating system; the foundation type; the types of loading; and/or the age of the wind asset.

The turbine tower geometry may comprise the width (or diameter) of the tower at the base and the zenith, and/or the wall thickness of the tower. These measurements may be based on the design schematics of the tower.

The foundation type may be a gravity-based structure (GBS), a monopile, Jacket on caissons, flexible piles, and/or the types of anchors used.

The type of loading considered may comprise wind, wave, sea-bed current, earthquake.

Calculating a vulnerability of the at least one first asset may comprise evaluating the service history or frequency of the at least first asset. Calculating a vulnerability of the at least one first asset may comprise the age of the asset.

The damage state of the at least first asset may comprise a state associated with a severity and a duration required for repair.

The state may be a predefined discrete state. The state may be a continuous probability function, or a continuous-time Markov chain. For example, obtaining the third probability of at least one damage state may include evaluating a plurality of assets associated with the generation, transmission, or storage of energy, and evaluating their impact on each other. For example, a transmission cable break caused by a storm may mean that electricity cannot be transferred from a wind turbine to a storage facility, which in turn cannot supply electricity to an electricity grid, or to a hydrogen or ammonia generating station or device. Thus, it may be possible to evaluate and include the knock-on effects of the plurality of first assets on each other, and also on the second asset(s).

Obtaining the first probability may comprise calculating an intensity measure of the wind and wave effect on the at least one first asset, the calculation may comprise: the sum of wind energy and wave energy per unit surface area averaged over the wave period.

Calculating the intensity measure may comprise using the following equation:

$$E = \frac{1}{8} {ρ}_{w} g {H}^{2} + \frac{1}{2} {ρ}_{a} {u}^{3} T$$

where:
a. E is the intensity measure;
b. u is wind speed at 10 m height (reference height);
c. g is the gravitational acceleration constant;
d. ρ_{w} is density of water;
e. ρₐ is density of air;
f. T is the predominant wave period; and
g. H is the significant wave height.

The intensity measure may be calculated for an offshore location. g may be the gravitational acceleration constant on earth.

The at least one first asset or second asset may be, or be a component part of, a wind turbine, an export cable suitable for exporting the electricity generated from the wind turbine from the wind turbine to an electricity storage unit or substation, a battery, an electrolysis plant, or a transmission cable suitable for transporting electricity from the storage or substation to a different location.

Obtaining the second probability of the of the non-natural adverse event occurring at the location of the at least one first asset may comprise obtaining the age of the at least one first asset.

The method may be computer-implemented.

According to a second aspect of the invention, there is provided a computing device performing the method steps of the first aspect.

According to a third aspect of the invention, there is provided a computer readable medium (CRM) having program instructions for performing the method of claim 1.

### BRIEF DESCRIPTION OF THE DRAWINGS

Certain embodiments of the present invention will now be described, by way of example, with reference to the accompanying drawings, in which:

FIG. 1 is a schematic diagram of a wind farm comprising wind turbines, power transmission and export cables, a battery, a converter, and an onshore substation;

FIG. 2 is a schematic of a wind turbine structure and the turbine inner components;

FIG. 3 is a perspective view of a wind turbine rotor nacelle assembly;

FIG. 4 is a schematic of a monopile type of system and a mechanical model describing sway;

FIG. 5 is a schematic of a mechanical model of a Tension Leg Platform (TLP) type wind farm system;

FIG. 6 is a schematic of different types of wind turbine foundations considered: a: GBS (Gravity Based Structure); b: Monopile; c: Suction Caisson; d: Seabed frame on pile; e: Jacket; f: Tension Leg Platform; g: Semi-Submersible; h: Spar;

FIG. 7 is an example of geological profiles for wind farm sites showing the variation of geotechnical properties.

FIG. 8 is a scatter plot of the rates power in megawatts for a wind turbine over time since 2004.

FIG. 9 is a process flow diagram of the method for vulnerability modelling of offshore wind turbines;

FIG. 10 is a process flow diagram showing the different types of seismic hazards on an offshore wind farm including the cascade hazards and multi-hazards;

FIG. 11 is a process flow diagram of insurance policy pricing for a particular type of offshore ocean energy asset (Generation+Transmission+Storage) at a given offshore location for different types of hazards (Natural and non-natural hazards) and a set of insurance policy conditions;

FIG. 12 is an example flowchart for analysis of a floating offshore wind farm system;

FIG. 13 is a schematic of an offshore windfarm comprising wind turbines, power transmission and export cables, a battery, a converter, and a substation;

FIG. 14 is a schematic of an offshore windfarm to support back-up cooling power to Nuclear Power reactors in seismic regions comprising wind turbines, power transmission and export cables, a battery, a converter, and an offshore substation; and

FIG. 15 is a schematic of an offshore windfarm and an electrolysis plant for the production of hydrogen;

### DETAILED DESCRIPTION OF CERTAIN EMBODIMENTS

Offshore Wind Farms (OWF) are a scalable clean energy sources deployed deep in the sea (for example, at a water depth of up to 200 m) far away from the shore (100 miles from seacoast). These are new expensive assets (typical average value of $1 billion for a 500 MW Power plant) and are currently being installed in a wide range of geographical areas. These assets can be classified as: generation assets (e.g., turbines), transmission assets (e.g., substations, transformers and cables) and storage assets (e.g., batteries, pumped hydroelectric power, compressed air, flywheels, thermal storage).

### Offshore Wind Farms Systems 1

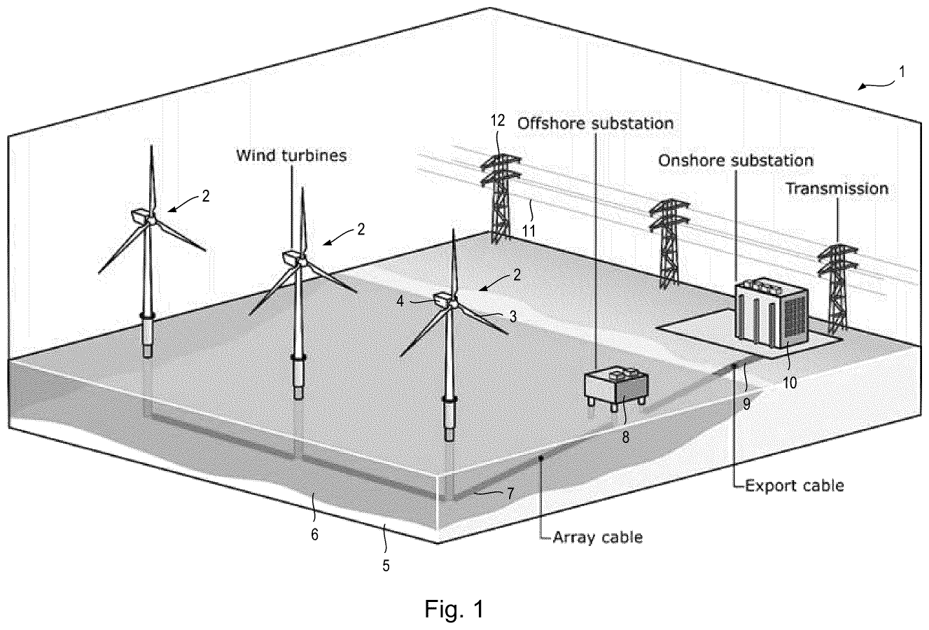

Referring to FIG. 1, an OWF 1 includes a wind turbine generator (WTG) 2, each wind turbine generator comprising one or more wind turbine blades 3, and a rotor-nacelle assembly (RNA) 4. The WTG 2 is anchored to the seabed 5, either directly, or may be floating in the sea 6 with tethers anchoring the WTG 2 to the seabed 5. Each WTG 2 is connected to an array cable 7 which transports the power in the form of electricity from the WTG 2 to, optionally, an offshore substation 8. The array cable 7 may be connected to any number of WTGs 2, for example, 1, 2, 5, 10, 20, 50, 100, or more than 1,000 WTGs. An export cable 9 may then transport the power from the offshore substation 8 to an onshore substation 10. Alternatively, the array cable 7 may transport the power from the WTG(s) 2 to the onshore substation 10 directly. The power is then transferred to the transmission cables 11 which may be part of the national or international grid or connected to the grid. The transmission cables may be underground, or may be supported by pylons 12.

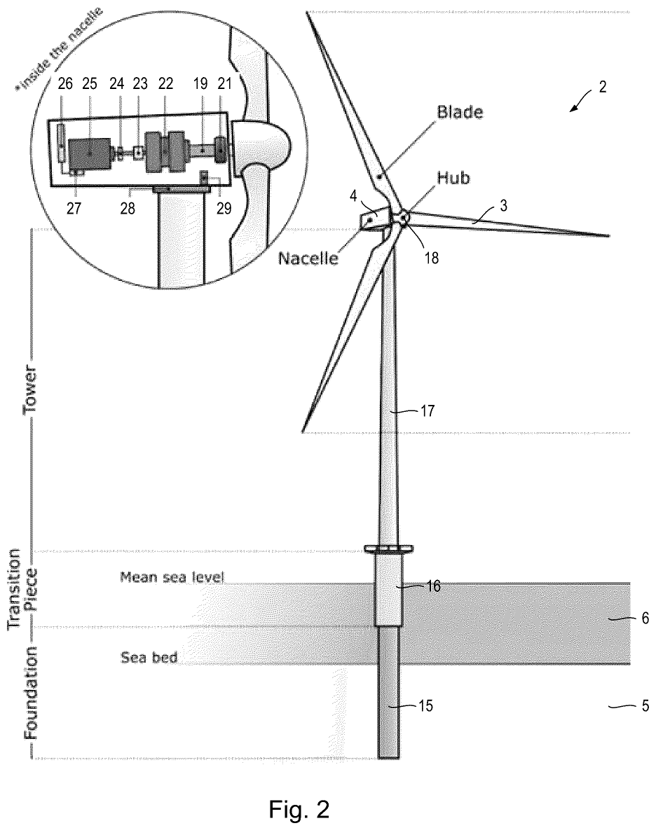

Referring to FIG. 2, the WTG 2 comprises a foundation piece 15 which is secured in or to the seabed 5, a transition piece 16, which is connects the foundation piece 15 to the tower piece 17 and is at sea level. As mentioned earlier, the WTG also includes one or more blades 3, and a rotor-nacelle assembly (RNA) 4. The blades rotate around a hub 18 which is connected to the shaft 20 of the RNA 4.

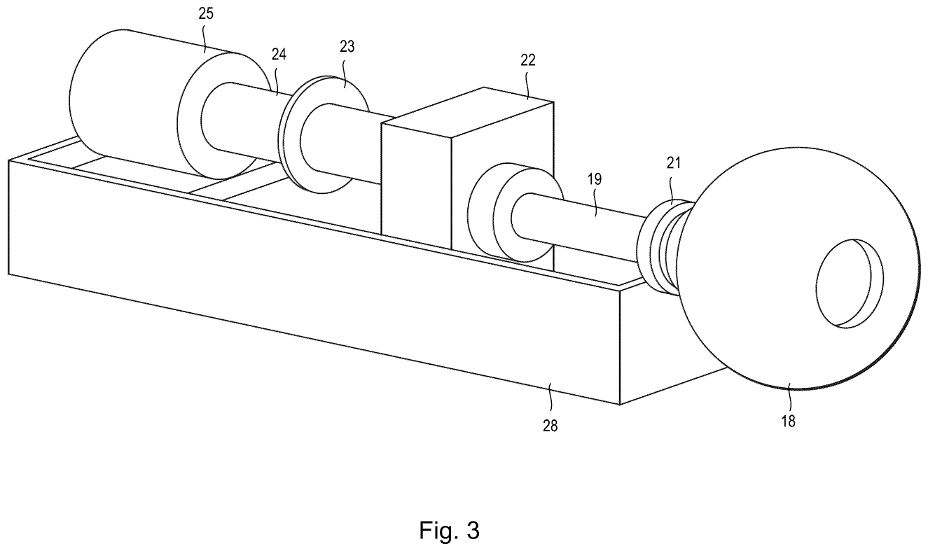

Referring also to FIG. 3, the rotor-nacelle assembly 4 includes a main bearing 21, a main shaft 19, a gearbox 22 to control the speed of the shaft relative to the speed of the wind/blades, brakes 23 to slow the shaft/blades is necessary, a clutch 24 to aid with changing gears, a generator 25 for generating electricity, a cooling system 26 for cooling the RNA 4, or components of the RNA 4, a heat exchanger 27 for aiding cooling of the RNA 4 or its components, a yaw drive 28 and yaw motor 29 to aid with the yaw positioning of the RNA 4. Any of these components of the RNA 4 has an associated risk with failure due to a number of factors, both natural and non-natural. For example, all of the components will have an expected minimum life under normal use, but occasionally, manufacturing problems may mean that there are defects in the components causing them to be at a greater risk of failure. Further, non-natural adverse events, for example a cyber-attack on the control system (not shown) of the WTG 2 may mean that the brakes 23 are not applied correctly, or at the right time, and thus lead to a failure of the gears within the gearbox 22, shaft 19, or other associated components. Natural adverse events may also increase the risk of failure of these components, for example, a tropical cyclone may increase the stress on the blades 3, making them more liable to break, or making the shaft 19 turn faster than it is designed to.

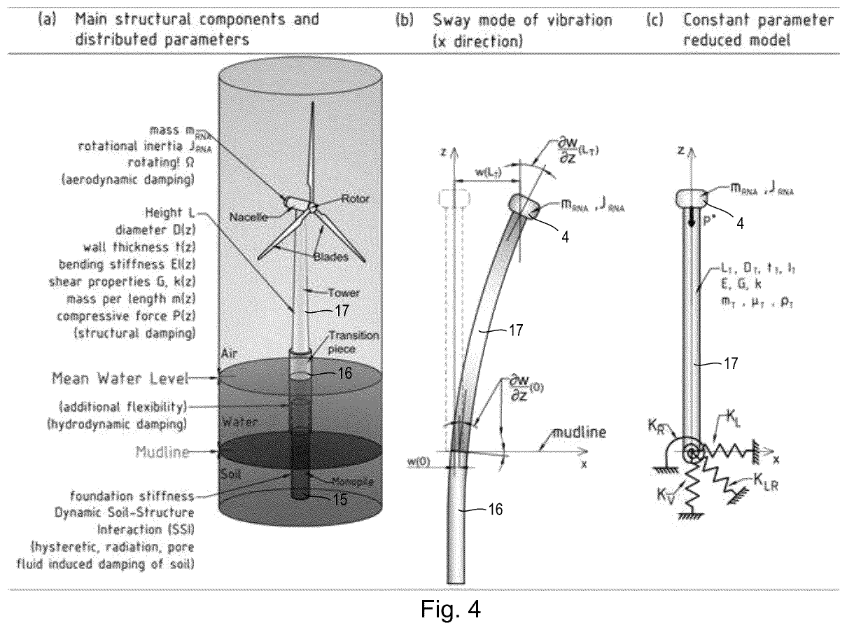

Referring to FIG. 4, natural adverse events or hazards may affect the tower piece 17. For example, wind caused by a storm, hurricane, or tropical cyclone may cause the tower piece 17, and possibly the transition piece 16 to sway, flex or bend. The degree of sway which the tower 17 can be subject to may depend on a variety of factors, for example, the diameter, wall thickness, bending stiffness, shear properties, mass per length of the tower, compressive force, and height of the tower 17. In addition, the mass, rotational inertia, and aerodynamic damping of the blades 3 and RNA 4, and the hydrodynamic damping, provided by or at the transition piece also affects the flexing of the tower 17. Thus, the materials, constructions methods, and design all have an effect on how much and how easily (i.e., the force required) for the tower to sway or otherwise deform. There may be a balance between allowing the tower 17 to sway a lot, and thus not putting undue stress on the tower 17, intermediate piece 16 and the foundation piece 15, and having a more rigid tower that while stronger, may put more stress on the materials or components of the WTG 2. The outcome of this balance may influence the risk associated with the assets concerned.

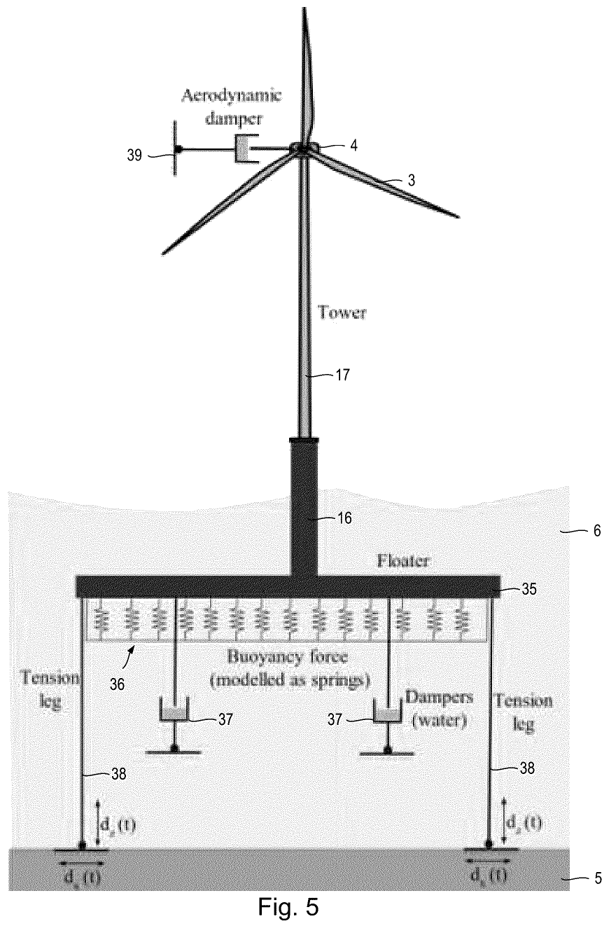

Referring to FIG. 5, the WTG 2 may be a floating WTG 2, where the tower 17 and the transition piece 16 are attached to a floating platform 35. The floating platform 35 may have a buoyancy device 36 to keep it off the seabed 5 and floating in or on the sea 6. Dampers 37 may be attached to the buoyancy device 36 to stabilize the movement of the tower 17 and thus the blades 3 and the RNA 4. The dampers 37 typically do not touch the seabed 5 but provide stability by making use of the hydrodynamics of the seawater moving around their structure (e.g., the shape of the structure can provide stability). Alternatively, the dampers 37 may be attached to, or be in contact with the seabed 5. Tension legs 38 attach the buoyancy device 35 to the seabed 5 meaning that it does not float away from a particular range of latitude and longitude. An aerodynamic damper 39 may also be included and attached to the RNA 4 to provide a damping effect, and thus additional stability from adverse weather, for example high winds, or a hurricane.

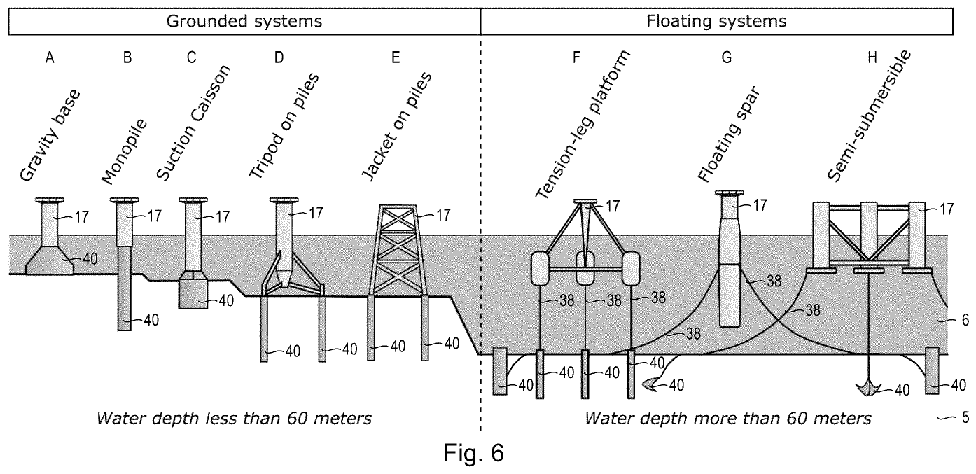

Referring to FIG. 6, WTG 2 may be attached to a variety of different towers 17. The towers 17 may vary in shape, strength, size, design, and in how they keep the RNA 4 stable. Five examples of WTGs 2 that have towers 17 or transitions pieces 16 attached to the seabed 5 are labelled A to E, and three examples of WTGs 2 which are floating and anchored to the seabed 5 using anchors 40 which are connected to the WTG2 through tension cords or legs 38 are labelled F to H. The floating WTGs 2 tend to be deployed in deeper water, where the grounded WTGs 2 are only possible in shallower water.

### Grounded Systems

Example A is a gravity-based structure (GBS) or platform. The GBS platform consists of a large concrete or steel structure that is placed on the ocean floor. Example B is a monopile structure which may include steel tubes driven into the seabed 5. Example C is an example of a suction caisson (also referred to as suction anchors, suction piles or suction buckets). Suction caissons are a form of fixed platform anchor in the form of an open bottomed tube embedded in the sediment of the seabed 5 and sealed at the top while in use so that lifting forces generate a pressure differential that holds the caisson down. Example D is of a tripod on piles, which has three piles embedded into the seabed 5, the top of the piles (that is, at or near the interface between the seabed 5 and the water 6) are connected by struts or supports to a monopole which is the tower 17. Example E is a jacket on piles, where, similar to the tripod on piles concept, the piles (for example two or more) are connected to a jacket (a structure for securing the WTG 2 to which may have several cross struts).

### Floating Systems

Example F is an example of a tension-lag platform, which is a type of floating system for securing a WTG 2 in position. A tension-leg platform (TLP) or extended tension leg platform (ETLP) is a vertically moored floating structure. A TLP is permanently moored using tethers or tendons at the structure's corners. The tethers may be grouped. A group of tethers is called a tension leg (see also FIG. 5). TLPs have relatively high axial stiffness (low elasticity), and as a result, nearly all vertical motion of the platform is eliminated, making them idea for WTG 2 placement. Example G is of a floating spar. A floating spar foundation is a large diameter vertical buoyant cylinder ballasted at the bottom end (the end closest to the seabed 5), and anchored to the seabed 5 with tethers 38 are one or more locations. The structure is therefore stable through high winds and currents. The cost of a floating spar may be less than the TLP. Example H is a semi-submersible platform which may comprise several columns, connectors, struts and connecting platforms. The centre of gravity may be above the centre of buoyancy. The stability of these platforms is achieved by the restoring moment of the columns. The platform is moored to the seabed 5 keeping it in position.

### Substrate Conditions

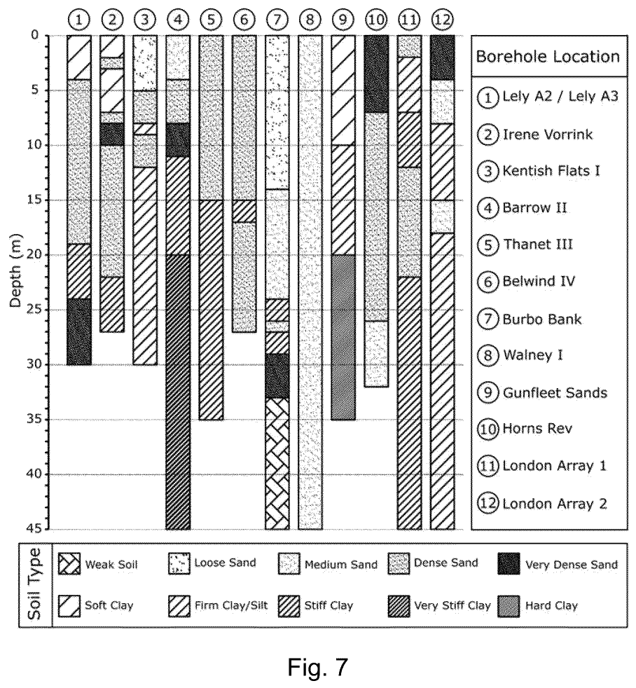

Referring to FIG. 7, anchors 40 of the foundation piece 15 are attached to the seabed 5 in a variety of different geological conditions which may affect how stable the connection is, and thus the risk of the connection failing, particularly if there is an earthquake, substrate liquification, a substrate slide, strong currents, or high winds putting undue tension on the tension legs 38 or anchors 40.

### Continuous Power Generation

OWF 1 are only power and revenue generating when both generation and transmission assets are operational. Additionally, in some systems, storage assets may also have to be operational for continuous power to be supplied and for revenue to be subsequently generated. Wind Turbine Generators 2 (WTG) are going through a massive innovation with rated power increasing from 3.6MW to 18 MW within a decade The length of the tower present above the seabed (60 m to 200 m), the length of the blades (40 m to 125 m) of the WTG, the mass of the Rotor-Nacelle Assembly (RNA) that sits on the top of the tower which houses the power generation equipment are have all seen changes in size to bring about the increased power generation capacity. Furthermore, the WTG supporting system, that is, the foundation to the seabed can be either grounded (fixed to the seabed) or, more recently, floating (tethered or anchored to the seabed through mooring lines).

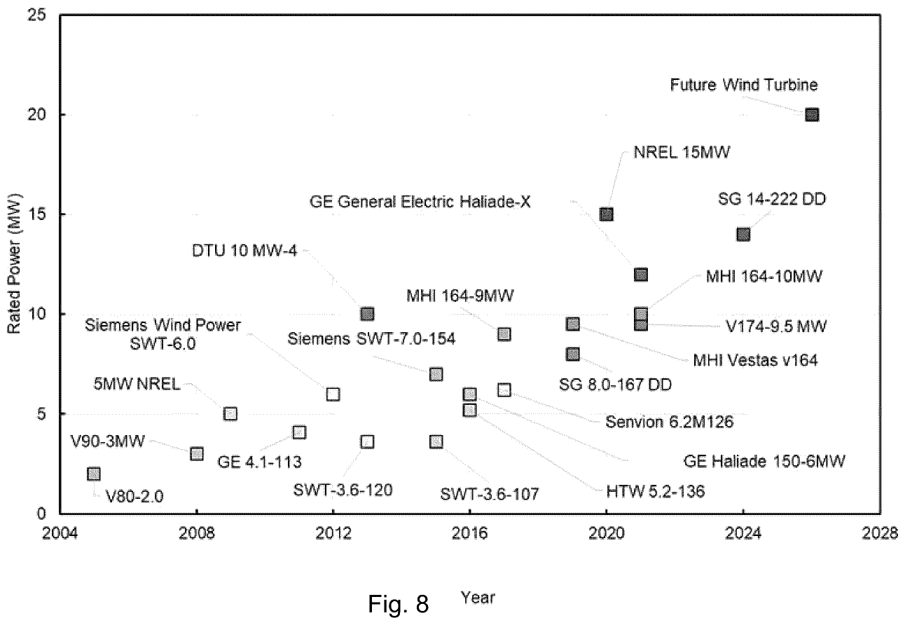

Referring to FIG. 8, there has been an increase in power rating of OWF 1 over the period from the year 2004 to present day, and projected to the year 2028, with some OWF 1 systems being designed to generate around 20 megawatts of power. This is a significant amount of power being generated and provided to consumers such as residents and industry. It is therefore more important than ever that the owners and operators of OWF 1 installations understand and properly assess the risks involved that could lead to a failure of the supply to their customers. Additionally, the failure in supply also results in a loss of revenue generation.

### Risks to Offshore Wind Farm Systems 1

There are many risks associated with the construction of offshore wind farms. For example, there are risks in the installation of generation assets such as turbines, and storage assets such as batteries, and the laying of transmission assets such as cables and operation of these assets throughout the entire life cycle. The life cycle of these assets includes the installation of all assets (which involves transportation of components from fabrication yards and storing them while the construction is going on), commissioning to generate electricity, and connection to the national and/or international grid, operation and maintenance and finally decommissioning.

These asserts must be inspected, serviced, and maintained to have an optimum life and avoid any unplanned downtime causing power generation, and thus, business interruption (including revenue generation). In many geographical locations, these assets are exposed to natural hazards. These may include tropical cyclones, winter storms, earthquakes and their related multi-hazards such as ground shaking, subsurface liquefaction, submarine landslides, tsunami and the like). It is therefore necessary to assess the performance of these assets. From a finance point of view, these risks are termed as “Catastrophic Risks”. It is necessary to predict and quantify the damages for a range of potential adverse events or hazards for a given geographical location. Furthermore, it is also required to estimate the cost of repair together with the downtime of these assets.

There are other site-specific hazards, for example, high seabed currents causing erosion of the foundation, complex geology (e.g., soft soils, or other substrate which is difficult to anchor to) presence of unexploded ordnance (UXO) at certain locations, and presence of shipwrecks and other buried objects. Furthermore, due to the offshore environment, there are degrading aspects such as corrosion of components exposed to sea water, and marine growth. The risks during construction and commissioning must also be assessed.

Prediction of damages for a given OWF for a particular natural hazard or adverse event also involves understanding the operations of the turbines when impending hazards (warning of tropical cyclones or the sensing of an impending earthquake or aftershock) are detected. While it is expected that the control system of the OWF, which is a complex electromechanical system, should operate so as to avoid any damage, there can be malfunctioning for a certain percentage of systems known as failure rate. The control system may also be at risk of sabotage, such as a cyber-attack.

Wind farm technology deployed at a given sea/ocean vary depending on many factors and predominantly on water depth (5 m to 500 m) which will dictate grounded or floating system, turbine size (3 MW to 20 MW), distance from the shore (substation type e.g., AC or DC), capacity of the wind farm and geology.

Because power and revenue are only generated when both generation and transmission assets are operational, any risk calculation or assessment must include all assets in the system, and their potential effect on each other. For example, if a transmission cable on the sea floor is damaged by an adverse event (e.g., a cyclone), it may be that there is no way of transferring the power generated from a WTG to a substation, storage, hydrogen generator (e.g., an electrolysis plant), or to the relevant national or international grid. Therefore, those in need of the power are left without, and additionally, no revenue can be generated from the WTG 2 of the OWF 1. Assessing the risk of the whole system can therefore allow an owner or operator of an OWF system to mitigate against the risk, for example, by installing additional assets as redundancies in key weak points in the system, or by insuring against the loss in revenue.

Therefore, there is a need for a risk assessment methodology which encompasses all the risks to the continual operation of an OWF system at a particular capacity. The inventors have developed a bottom-up physics-driven methodology to have a structured approach to evaluate the physical risks (that is, damages) and subsequently translating them to a quantifiable power loss, business interruption and associated financial loss which includes the potential downtime and business interruption.

OWF 1 supply chains are complex and involve obtaining rare earth material, which further increases the risk and uncertainty when trying to repair damaged components of WTGs 2.

The inventors have found that using their holistic analysis methodology including “systems effect” of an offshore wind farm 1 allows owners and operators to properly assess the risk of inoperable OWF 1 time, and may allow them to mitigate accordingly.

### Assessing Risk

The methodology steps may comprise:

Defining damage states for various assets (power generation assets, transmission assets and expensive components) that impacts downtime and financial losses. This is based on extensive collective experience of the sector.

Carrying our engineering analysis for a range of offshore wind assets (that are operational, currently available in the market and future design) to predict the damages for different hazards. This is purely science driven and often finite element analysis is carried out. Monte Carlo simulation is carried out to consider the uncertainty.

Quantifying potential hazards for a given location corresponding to different return period. This is based on obtaining data from various sources and simulations where required.

Estimating the cost of repair of for a given asset for a particular hazard. Furthermore, the time required to carry out the repair is also estimated which informs the financial losses. These costs are normalised to the cost of replacement and is expressed as MDR (Mean Damage Ratio).

Quantifying insurance pricing and categorise banking credit risks using appropriate technology using the above data and analysis.

The input variables used for the model can be grouped are:

TABLE 1
input variables used for the model

| Model Variables | Parameters | Remarks |
|---|---|---|
| Asset definition | Rated Power | This is taken into account |
| [Turbine class, Substation | RNA Mass | through Turbine Dictionary. |
| type and Cables] | Tower Height | |
| | Blade type | |
| | Direct Drive or Geared | |
| Geographical location | Water depth | |
| parameters | Wind field | |
| | Wave characteristics | |
| | Current profile | |
| | Seismic Characteristics | |
| | Geology profile | |
| Concept | Fixed Systems | |
| | Floating System | |
| Foundation Type | Monopile | |
| | Jacket on caissons or piles | |
| | Gravity Base | |
| Age of the installation | | This takes into account the |
| | | effect of corrosion |
| Scour Protection | Yes or No | |
| Cable Protection System | Yes or No | |
| Substation Type | e.g., on shore, off shore, or | |
| | other specifications | |
| Export Cable Type | e.g., may include cable | |
| | thickness, composition, | |
| | length, material, and the like | |
| Array Cable type | e.g., may include cable | |
| | thickness, composition, | |
| | length, material, and the like | |

Many parts of the methodology are validated and calibrated using the field data and well-calibrated scaled model tests.

As discussed above, offshore wind farms are a new asset class comprising of 3 distinct functionalities:
Generation Assets: These generate electric power and are known as “wind turbines” which can be supported on floaters that are anchored/tethered/moored to the seabed (Floating Wind Turbines) or grounded to the seabed through a suitable support structure (Fixed Wind Turbines). The main components are: blades, generator (electro mechanical system), tower, foundations and Transition Piece.
Transmission Assets: These transfer the power generated by the wind turbines to the National Grid. The main components are: array cables, export cables and sub-stations including transformers.
Storage Assets: These store power and acts as a dispatchable fuel. They are typically batteries and H2 (hydrogen) storage.

Understanding the various constituents of a WTG is essential before discussing the types of failures and failures mechanisms associated with a WTG.

TABLE 2
components of a wind turbine generator

| Component | | |
|---|---|---|
| No. | Name | Failure Mode |
| 1 | Base | Scour, Corrosion, Erosion, rotation, settlement or |
| | (Foundation) | displacement, sliding |
| 2 | Tower | Fatigue, Corrosion, Erosion, Overload |
| 3 | Blades | Mechanical and aerodynamic Imbalance, Cracking, |
| | | debonding, Roughening, lightening Damage |
| 4 | Meteorological | Build-up of ice, Seizure, Impact damage |
| | Unit | |
| 5 | Nacelle | Yaw bearing Failure, Over-temperature, Seal Failure |
| 6 | Pitch system | Pitch bearing failure, seizure, overloading, hydraulic oil |
| | | leakage, |
| 7 | Hub | Fracture, Corrosion |
| 8 | Main bearing | Bearing failure, misalignment, lubrication |
| 9 | Low speed shaft | |
| 10 | Gearbox | Fracture, Wear, loss of lubricant, tooth failure |
| 11 | High speed shaft | Cracking, Permanent bent |
| 12 | Brake system | Error or malfunctioning |
| 13 | Generator | Misalignment, perishing, wear, fracture, short turn |
| 14 | Yaw system | Yaw bearing failure; yaw ring wear; yaw ring distortion or |
| | | damage; yaw motor failure; yaw brake failure; yaw brake |
| | | seizure; yaw alignment error |
| 15 | Converter | Malfunctioning |
| 16 | Bedplate | Corrosion |

These relatively new assets are moving to new geographical areas. Understanding meteorological and oceanographic conditions is key to planning and reduce operational/construction risks.

The risks can be classified as:
Technology Risks: Wind Turbines are going through massive evolution in terms of sizes: 3MW to 16MW within a span of 10 years. The blades are getting longer and heavier.
Location Risks: [Water depth, Geology, Wind, Wave, Earthquake, Tsunami, Sea current, Rain, Temperature]
Construction Risks and errors: Pile run during installation (Yunlin, Changsha), Boat impact, Pile tip buckling, buckling of suction caissons, errors in installation of components, errors in grouting of the connections, large defective components.
Ageing: With time, different components degrade such as corrosion of the steel components,
Operational Risks: Cyber risks, cable, and control system malfunctioning

Catastrophic Modelling is used for this purpose and this document explains the basis of CAT (catastrophic) modelling and where possible justification is provided for the important steps.

Fit-for-purpose engineering analysis forms the backbone of CAT (catastrophic risk) modelling. Fit-for-purpose methods depending on a range of factors: rigour necessity, data availability etc. If the data has high level of uncertainty there is little merit in rigorous analysis.

There are existing models for Quantitative Risk Assessment (QRA) for individual assets or components of such assets such as: grounded wind turbines on monopile foundations for earthquake hazards which is a particular generation asset or component of a generating asset such as wind turbine blades or gearboxes. But these are limited by their narrow scope—only considering single assets, and now the network effects that risks to the operation of one asset can have on other assets in the OWF system 1.

In contrast, the holistic methodology of the present application evaluates the whole wind farm system 1 comprising of 3 types of assets: Generation+Transmission with or without Storage. The use of the power for generating storage assets, such as hydrogen through electrolysis, or nitrogen generation, is also considered. It is noted that all these assets are inter-dependent as generation of power without transmission or storage does not generate revenue, and users do not receive power.

Offshore wind farms are a collection/network of wind turbines (25 to 200) generators mounted on a support structure and each of these turbines are generation asset. The present methodology quantifies the dependencies between assets in the overall wind farm (i.e., network of assets) and incorporates the consequences of malfunctions or failures of a single asset or a component of an asset i.e., takes into account the “systems effect”. Examples include the malfunctioning of control system of one turbines out of a series of 200 turbines during an event or the rupture of one array cable connecting two turbines.

The tasks involve construction of individual vulnerability functions for each type of functional assets incorporating the vulnerability of relevant sub-components for different types of hazards (tropical cyclones including typhoon and hurricane, earthquake and connected multi-hazards such as strong shaking, liquefaction, submarine landslide, tsunami, seabed scour, ice and rainfall) and creation of scenario-based total vulnerability. Examples of individual vulnerability functions include blades 3 subjected to hurricane, offshore export cable subjected to submarine landslide, grounded wind turbine 2 on monopoles 15, 16, 17 subjected to subsurface liquefaction, floating system subjected to fault rupture.

Vulnerability functions are generated using the developed methodology described later. The methodology presented here is first systematic methodology to combine component-wise damage estimations of a complex asset such as an offshore wind farm system used on its own or the following:

In conjunction with a nuclear power plant for enhancing resilience of cooling power
in conjunction with battery storage
in conjunction with hydrogen (H₂) storage

Use of OWF 1 for adding resilience to nuclear power plants is proposed and discussed later, but the method to comprehensively assess risk is provided in this work.

The quantitative risk assessment methodology presented here is a structured and systematic process that analyses and assesses the risks associated with the complex inter-connected systems of generation, transmission and storage. The methodology involves the use of a series of fit-for-purpose analysis that involves analytical solutions (closed form formulaic solutions), numerical models (finite element method) together with statistical methods to evaluate the likelihood and consequences of given hazards, and to estimate the potential physical damages. For rare events (low probability but high consequence such as large magnitude earthquakes or tropical cyclones) vulnerability functions are based on numerical simulations and the simulation considers the following:

A range of turbines based on our turbine dictionary for rated power between 2MW and 20MW defined by RNA (Rotor Nacelle Assembly) mass, blade geometry and material. This is based on the ongoing technology advancement in turbine rated power between 2004 and 2028, see FIG. 8.

Wind Turbine tower geometry (bottom and top diameter and wall thickness) based on design.

Range of water depths where wind farms are likely to be deployed

Two types of systems are considered: Grounded System and Floating System [see FIG. 6 where (A) to (E) are grounded and (F) to (H) are floating]

Range of foundation types: gravity-based systems, monopile, jacket on caissons or flexible piles, and the types of anchors

Different types of loading such as wind, wave, sea-bed current, earthquake

Effect of age of the wind farm due to degradation of materials such as corrosion of steel or blade erosion or scour are also considered.

All the above simulations generated bespoke vulnerability functions (VF) and the methodology is based on calibrated simulations.

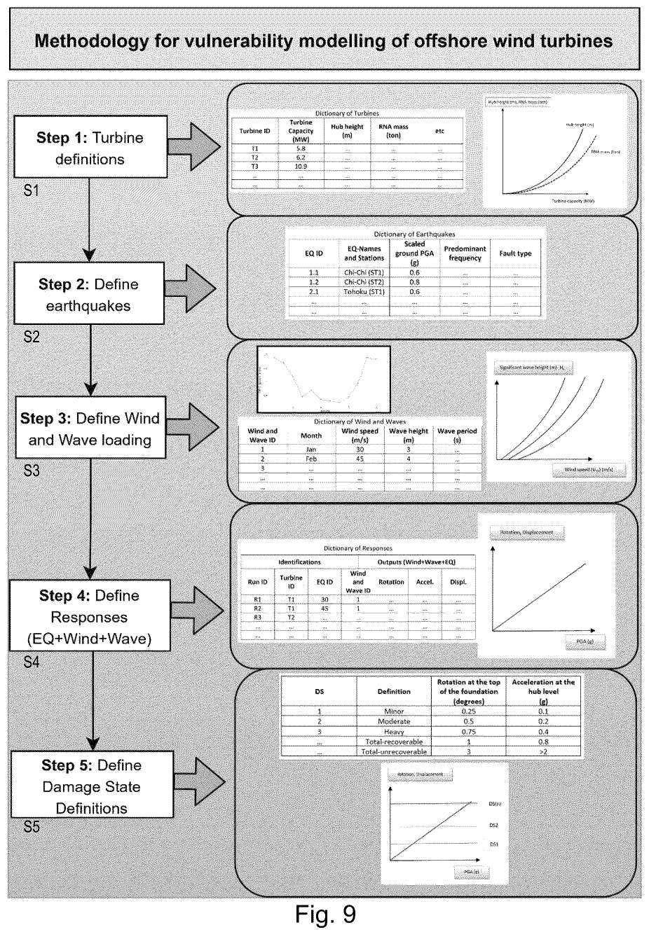

Referring to FIG. 9, a generalized flow diagram of the methodology for derivation of vulnerability functions shows the process of the above methodology. Hazards related to seismic events is available in [3] and design details of foundations are available in [4]. The methodology is validated based on published literature or scaled model tests. Some examples of validation of our methodology are:

Scour effects on wind turbines is calibrated based on Robin Rigg wind farm as provided in [5]

Seismic effects of wind turbines in liquefiable soils based on a case record from 2011 Tohoku earthquake [6] and scaled model tests [7]

Referring still to FIG. 9, at step 1 (S1), the turbine definitions are determined, these may include various metrics about the turbine 2, for example, the capacity in power generation, the hub 18 height, the RNA 2 mass, and other metrics mentioned earlier. In step 2, (S2), the earthquakes are defined, for example, the name, the scaled ground peak ground acceleration (PGA), the predominant frequency of the earthquake, and the fault type may be included. In step 3, (S3), the wind and wave loading are determined, which may include time, wind speed, wave height, wave period, and other associated relevant metrics. In step 4 (S4), the responses are defined for all the earthquakes, wind and wave loading for each of the identified assets. In step 5 (S5), the damage state definitions are defined, which include severity of the effects on the turbines, for example, rotation at the top of the foundation, and acceleration at the hub level. The greater the damage for each metric of the wind turbine, the higher the damage state.

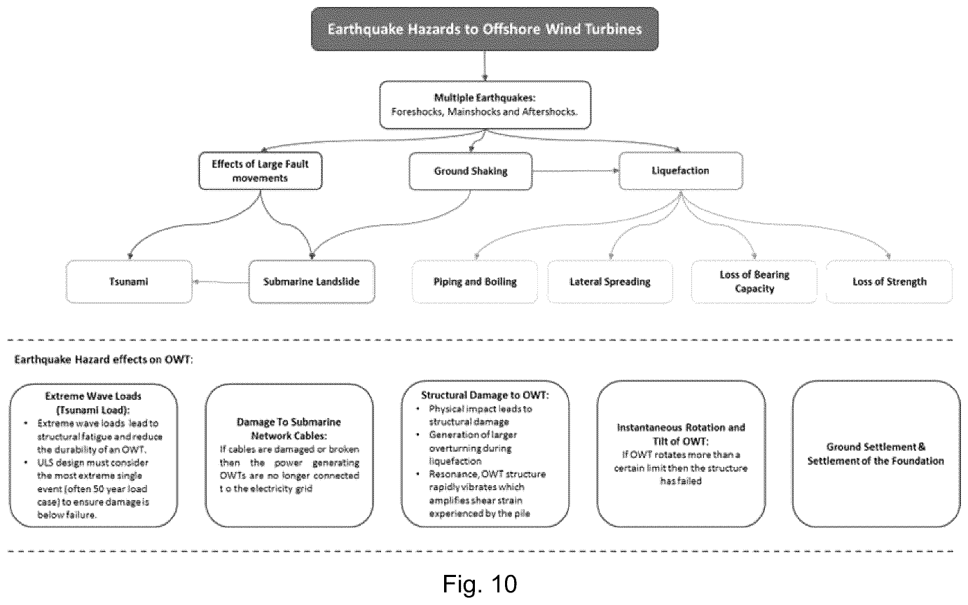

Referring to FIG. 10, OWF 1 as a whole, during an earthquake, will be subjected to different sets of multi-hazards such as strong shaking, liquefaction induced slope movement, settlement of foundation and are incorporated in the methodology. FIG. 10 shows the range of hazards considered. For example, multiple earthquakes may include foreshocks, mainshocks and aftershocks. Each of these may result in large fault movements, ground shaking, and liquefaction of the substrate. The large fault movements may cause a tsunami and/or a submarine landslide. The ground shaking may also cause submarine ground shaking, and/or liquification. Liquification of the substrate may cause piping and boiling, lateral spreading, loss of bearing capacity on the WTG 2, and/or loss of strength of the WTG 2.

Earthquakes may therefore affect the WTG 2 in a number of ways. For example:

Extreme wave loads, e.g., from a Tsunami may lead to structural fatigue, and reduce the durability of an WTG 2. Ultimate limit state (ULS) design must consider the most extreme single event (often a 50-year load case), to ensure damage is below failure.

Damage to submarine network cables. For example, if the cables are damages of broken, then the power generating WTGs are no longer connected to the electricity grid and cannot provide power to the consumers, and thus a loss of revenue is incurred.

Structural damage to WTG 2. Physical impact leads to structural damage. Generation of larger overturning during liquefaction. Resonance, WTG 2 structure rapidly vibrates which amplifies shear strain experienced by the pile.

Instantaneous rotation and tilt of WTG 2. If the WTG rotates more than a certain limit, then the structure fails.

Ground settlement and settlement of the foundation can cause the WTG 2 to fall, rotate or otherwise fail.

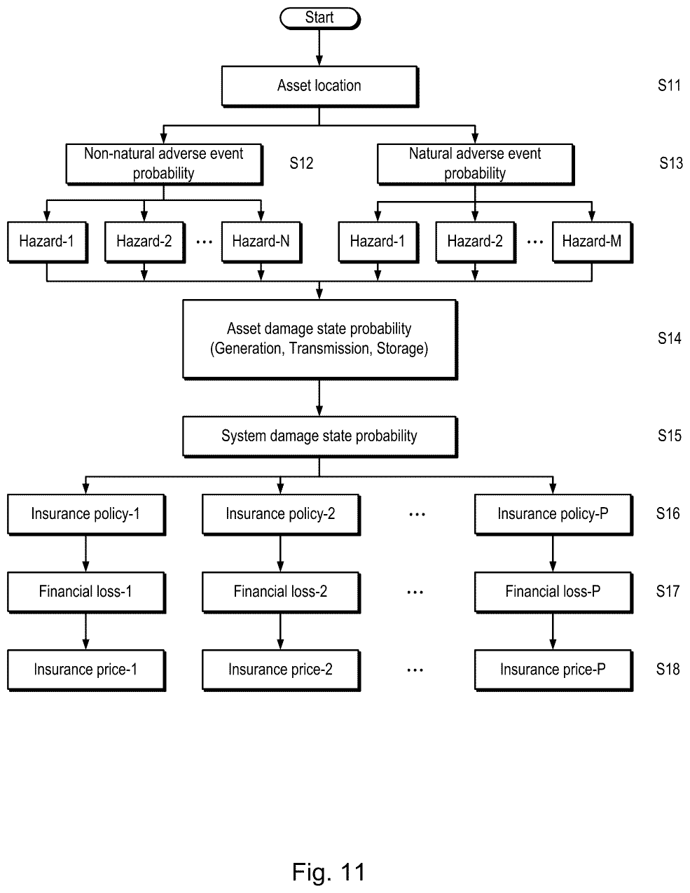

Referring to FIG. 11, an asset location is obtained (step S11). The asset location may comprise a depth below sea level. The location may comprise bathymetry information, that is, the underwater depth information of a body of water. The method may further comprise obtaining time-varying information for the location, for example over a day, over a week, month, quarter, year, decade, generation, or century. The method may further comprise obtaining time-varying information for the location, for example the time of day, the time of year for the time period concerned, or time periods either side of the time period concerned. The method may further include obtaining predicted climate or weather information, for example, changes predicted from climate change models either during, or either side of the time period concerned. The time-varying information may influence the first and/or second probabilities, for example, there may be an increased risk of cyclones in 10 years' time at the location than there is at present.

For each asset, the probability of a natural adverse event (also referred to as a hazard—hazard-1, hazard-2, . . . , hazard-N) occurring at the asset location is obtained (step S12). The natural adverse event is associated with a severity.

For each asset, the probability of a non-natural adverse event (also referred to as a hazard—hazard-1, hazard-2, . . . , hazard-M) occurring at the asset location is obtained (step S13). The non-natural adverse event is associated with a severity.

For each asset in a system, for example an offshore windfarm, the probabilities that the adverse events occur, and their severities, are combined to generate an asset damage state probability for that asset (step S14). This may be over a time period, for example, a year. The probabilities adverse events occur, and their severities for each asset (for example a wind turbine and a transmission cable) in a system are combined to generate a system damage state probability (step S15). Thus, the amount of time a system is inoperable for is determined. This allows the owner of a system of asset(s) to mitigate loss from having an inoperable power generation system. Potential mitigation can take the form of extra redundancy in key assets, readiness of spare parts, particularly where lead times can be long, and additional capacity in the system (e.g., in generation or storage) to offset power generation loss. Additionally, or alternatively, the system owner can use the system damage state to insure against the losses to power generation.

The system damage state probability can be used to calculate a projected average financial loss for a period of time. This may be synergistic and take account of the whole system, for example, damage to a transmission cable impacts the ability of the whole system to provide power to an electricity grid, and therefore financial loss is for the whole system, despite only one asset being affected.

Different insurance policies can be prepared (step S16) based on the average system damage state probability which provide different levels of protection. These levels of protection insure for different financial losses (step S17). Each insurance policy will be associated with an insurance price (step S18).

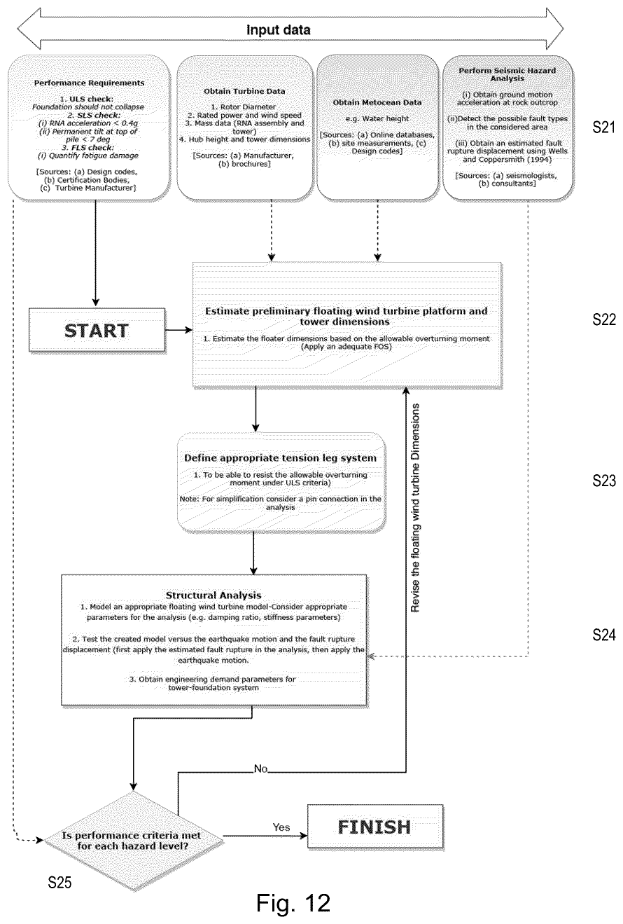

Referring to FIG. 12, an example of a flowchart for assessing the downtime risk, and therefore also the potential financial implications of losing the function, of a floating wind turbine generator 2 asset for a period of time. First, input data are obtained from various sources (step S21). As will be explained in more detail later, input sources may include performance requirements, turbine data, metocean data, and seismic hazard analysis data.

When assessing the risk, the input data may include the performance requirements (also known as “Limit States”), which may include an ultimate limit state (ULS) check, for example, a check that the foundation should not collapse. The performance requirements should further include a serviceability limit state (SLS) check, which may include RNA acceleration being less than 0.4 g, that the permanent tilt at the top of the pile is less than seven degrees (7°). The performance requirements may also include a fatigue limit statistic (FLS), for example, quantification of the fatigue damage to the asset (e.g., the WTG 2, cable, substation etc.). Accidental Limit State (ALS) is also assessed. In summary, the performance requirements comprise:
ULS—Ultimate Limit State to ensure that under extreme load conditions (in its life time) it does not collapse;
SLS—Serviceability Limit State which ensures that the deformation or movements under working/operating conditions does not affect the power production performance;
FLS—Fatigue Limit State which ensures that the various materials in the turbine system will not fail by fatigue during the lifetime (typically 25 to 30 years);
ALS—Accidental Limit State to ensure that under accidental loads (such as boat impact etc) the structure will not be written-off completely.

The sources of these inputs may be design codes, certification bodies, and/or the manufacturer of the parts or devices being assessed.

Data on the turbine is also obtained, for example, rotor diameter, rated power and wind speed, mass data of the asset (e.g., RNA assembly and tower), and/or hub height and tower dimensions. The sources of these data may be from the manufacturers of the devices (or parts thereof), or other available information like brochures for the assets.

The metocean data is obtained, which may include, for example, the water height (or a range, with peaks and troughs also accounted for). The sources of this information may include online databases, site measurements, and/or design codes.

Metocean data may include the combined wind, wave and climate (etc.) conditions as found on a certain location. These data may include seasonal variations, scatter tables, wind roses and probability of exceedance. Metocean conditions may include, depending on the project and its location, statistics on meteorology (e.g., wind speed, direction, gustiness, wind rose and wind spectrum, air temperature, humidity, occurrence and strength of typhoons, hurricanes and (other) cyclones). Metocean data may include physical oceanography, for example water level fluctuations (e.g. historical, expected and seasonal sea level changes, storm surges, tides, tsunamis, seiches, and wind waves—wind seas and swells—characterised by statistics like: significant wave heights and periods, propagation directions and (directional) spectra), bathymetry, salinity, temperature and other constituents, stratification, density-driven currents and internal waves, and ice occurrence, extent, thickness, strength and seabed gouging.

A seismic hazard analysis is also performed and used as an input. For example, the ground motion acceleration at rock outcrop is obtained, the possible fault types in the considered area are detected, an estimate fault rupture displacement is obtained (for example using the method described in Wells and Coppersmith 1994, Bulletin of the Seismological Society of America, Vol. 84, No. 4, pp. 974-1002). Sources for these data may be from seismologists, consultants, and/or measurements.

Starting with the performance requirements, the preliminary floating wind turbine platform and tower dimensions are estimated using the turbine data and the metocean data, and the floater dimensions based on the allowable overturning moment is estimated (an adequate factor of safety may be applied) (step S22).

Next, an appropriate tension leg system is defined (step S23) which is able to resist the allowable overturning moment under ULS criteria (e.g., the consideration of a pin connection in the analysis).

A structural analysis is then performed (step S24) using these outputs, and the input of the seismic hazard analysis. First an appropriate floating wind turbine model is modelled. Appropriate parameters for the analysis are considered, e.g., damping ratio, stiffness parameters etc.). Next, the generated model is tested against the earthquake motion and the fault rupture displacement. To do this, first the estimated fault rupture in the analysis is applied, and then the earthquake motion is applied. Then the engineering demanded parameters for tower-foundation system are obtained.

Considering the performance requirements of the WTG 2 (or other asset), an assessment of the performance criteria for each hazard (e.g., adverse event) level is performed (step S25). If these are met, the process finished. If these are not met, the dimension of the floater (e.g., floating support) or the support structure such as the tower 17 are revised and the process is performed again (back to step S22), and new performance requirements are considered as input data.

For example, starting with an initial guess using the performance requirements input data described earlier, the various performance requirements are checked. If one of the various checks fail, the dimensions of the floating wind turbine platform and/or tower are increased, and the analysis is performed again to make sure all the limit states are satisfied.

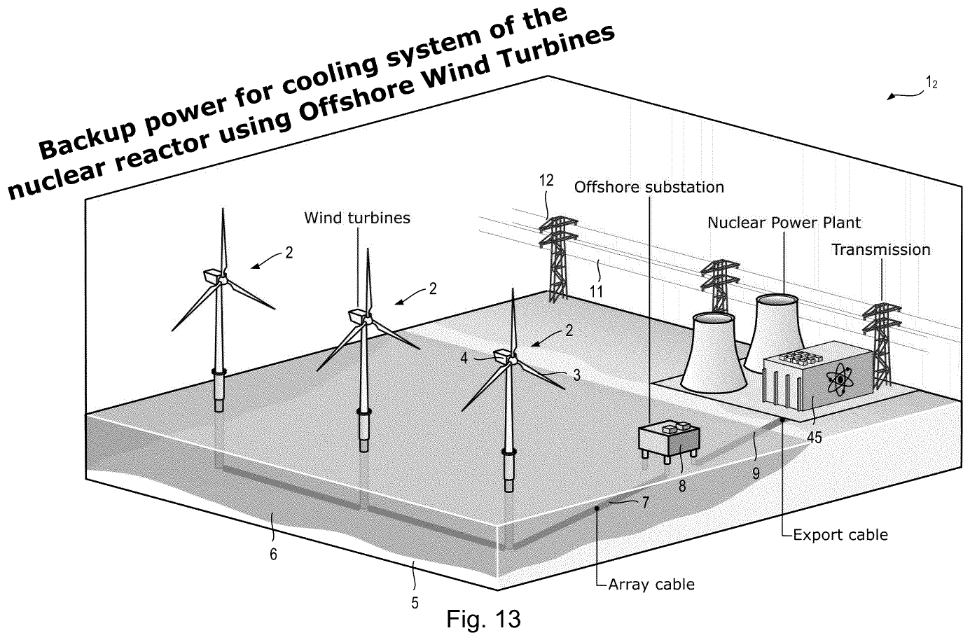

Referring to FIG. 13, a second offshore windfarm system 12 is similar to the first system 1, but instead of the onshore substation, the system 12 includes a nuclear powerplant 45, which may be cooled using the power from the OWF system 12. This cooling may be from using the electricity generated from the OWF to pump water around the part which need cooling or may be by using that energy to cool the necessary part in a different way, for example, by powering refrigeration.

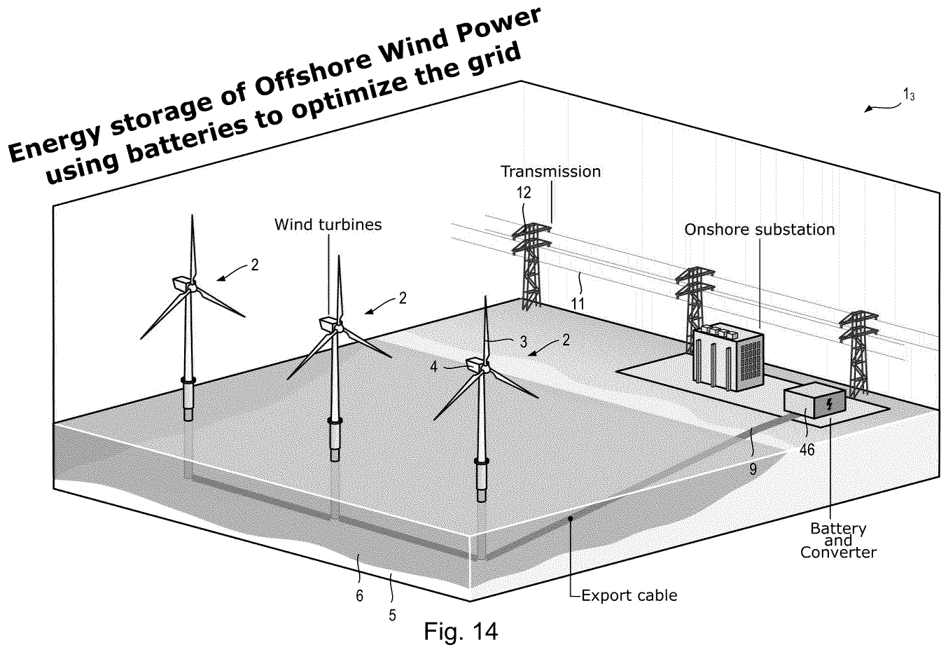

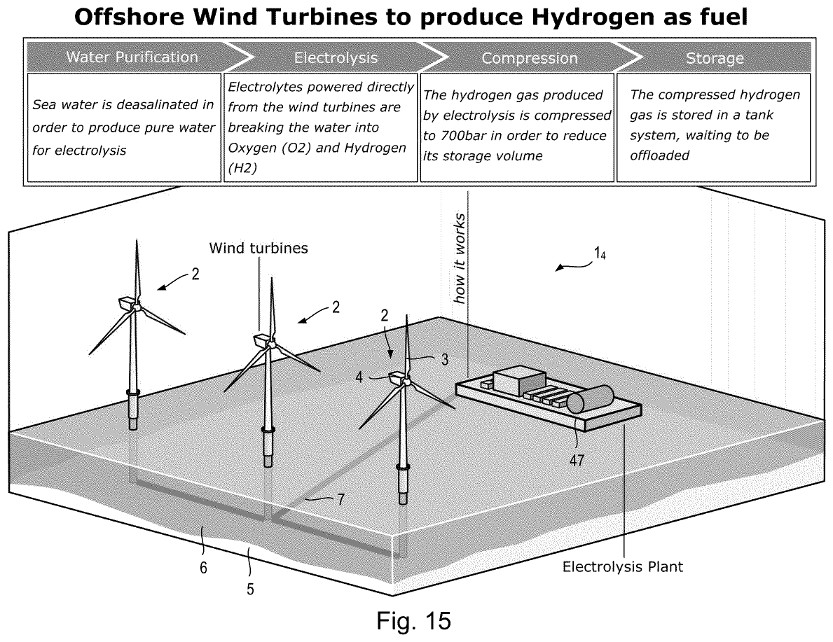

Referring to FIG. 14, a third offshore wind farm system 13 may be similar to the first offshore wind farm 1 and may include a battery for storing the electricity generated by the OWF 13. Referring to FIG. 15, an offshore wind farm 14 may also include an electrolysis plant 47 or a nitrogen generating plant for the generation of hydrogen and nitrogen respectively. The hydrogen or nitrogen may be used as fuel, or as a storage means.

### Modifications

It will be appreciated that various modifications may be made to the embodiments hereinbefore described. Such modifications may involve equivalent and other features which are already known in the design and implementation of methods for determining an average duration for a time period that the at least one first asset, or a second asset operatively connected to the at least one first asset, is inoperable and which may be used instead of or in addition to features already described herein. Features of one embodiment may be replaced or supplemented by features of another embodiment.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A method comprising:
obtaining a location of at least one first asset associated with energy generation, transmission, use, or storage;
obtaining a first probability of a natural adverse event occurring at the location of the at least one first asset, the natural adverse event having an associated severity;
obtaining a second probability of a non-natural adverse event occurring at the location of the at least one first asset, the non-natural adverse event having an associated severity;
determining a third probability of at least one damage state of the at least one first asset from the first and second probabilities and their associated severities; and
determining an average duration for a time period that the at least one first asset, or a second asset operatively connected to the at least one first asset, is inoperable based on the third probability of the at least one damage state of the first asset.

2. The method of claim 1 comprising:
determining an average annual financial loss based on the average duration for the time period that the at least one first asset or second asset are inoperable, and the cost of repairing the asset to return the at least one first asset and/or second asset to a functional state.

3. The method of claim 1 wherein the location comprises a latitude and a longitude.

4. The method of claim 1 wherein the at least first asset associated with energy generation is a turbine.

5. The method of claim 1 wherein the at least first asset associated with energy generation is a wind turbine.

6. The method of claim 1 wherein the asset associated with transmission is a substation, a transformer, or a cable.

7. The method of claim 1 wherein the asset associated with storage is a battery, or an electrolysis plant.

8. The method of claim 1 wherein the natural adverse event comprises a seismic activity, an airflow activity, a waterflow activity, lightening, fire, or flooding.

9. The method of claim 1 wherein the first probability is determined by calculating a vulnerability of the at least one first asset.

10. The method of claim 9 wherein calculating the vulnerability of the at least one first asset comprises an analytical solution, a numerical model, a statistical method, or a numerical simulation, to evaluate the likelihood and consequences of a given natural or non-natural adverse event.

11. The method of claim 10, wherein the numerical model comprises a finite element analysis.

12. The method of claim 11, wherein the at least one first asset associated with energy generation, transmission or storage is an asset associated with a wind turbine or a windfarm, and when the method comprises a numerical simulation, the simulation comprises any of:
a range of generation assets from a pre-defined list of assets categorised by:
rotor nacelle assembly mass; and/or
turbine blade geometry and/or material;
turbine tower geometry;
a range of water depths typical of a wind farm;
whether the wind turbine is a grounded system or a floating system;
the foundation type;
the types of loading; and/or
the age of the wind asset.

13. The method of claim 1 wherein the damage state of the at least first asset comprises a state associated with a severity and a duration required for repair.

14. The method of claim 1 wherein obtaining the first probability comprises calculating an intensity measure of the wind and wave effect on the at least one first asset, the calculation comprising:
the sum of wind energy and wave energy per unit surface area averaged over the wave period.

15. The method of claim 14, wherein calculating the intensity measure comprises using the following equation:
$$E = \frac{1}{8} {ρ}_{w} g {H}^{2} + \frac{1}{2} {ρ}_{a} {u}^{3} T$$
where:
E is the intensity measure;
u is wind speed at 10 m height (reference height);
g is the gravitational acceleration constant;
ρ_{w} is density of water;
ρₐ is density of air;
T is the predominant wave period; and
H is the significant wave height.

16. The method of claim 1, wherein the at least one first asset or second asset is, or is a component part of, a wind turbine, an export cable suitable for exporting the electricity generated from the wind turbine from the wind turbine to an electricity storage unit or substation, a battery, an electrolysis plant, or a transmission cable suitable for transporting electricity from the storage or substation.

17. The method of claim 1, wherein obtaining the second probability of the of the non-natural adverse event occurring at the location of the at least one first asset may comprise obtaining the age of the at least one first asset.

18. The method of claim 1 wherein the method is computer-implemented.

19. A computing device performing the method steps of claim 1.

20. A computer readable medium (CRM) having program instructions for performing the method of claim 1.
